(19) United States
(12) Patent Application Publication
(10) Pub. No.: US 2019/0255574 A1
(43) Pub. Date: Aug. 22, 2019

(54) INSTALLATION ARRANGEMENT AND METHOD FOR THE AUTOMATED CLEANING OF LAMELLAR HEAT EXCHANGERS

(71) Applicant: MYCON GmbH, Bielefeld (DE)

(72) Inventor: Jens-Werner KIPP, Bielefeld (DE)

(73) Assignee: MYCON GmbH, Bielefeld (DE)

(21) Appl. No.: 16/399,132

(22) Filed: Apr. 30, 2019

Related U.S. Application Data
(63) Continuation of application No. PCT/DE2017/100700, filed on Aug. 22, 2017.

(30) Foreign Application Priority Data
Oct. 31, 2016 (DE) 10 2016 013 001.6
Jan. 31, 2017 (DE) 10 2017 101 850.6

(51) Int. Cl. B08B 3/02; B05B 7/00; B05B 7/04; B08B 11/00; F28G 1/16

(52) U.S. Cl. CPC B08B 3/024; B05B 7/0075; F28G 1/166; B08B 11/00; B05B 7/0483

(57) ABSTRACT

A method for the automated cleaning of lamellar heat exchangers and other sensitive surfaces, a moving apparatus, preferably moved on rollers or skids, being moved up and down on a guide unit made up of one and preferably two guide rails, on which a support arm is mounted, on which at least one and preferably multiple spray nozzles are mounted in such a way that they are moved along with the guide unit via the moving apparatus with the aid of an additional drive unit via a roller or toothed wheel mounted on another end, a carrier gas, preferably compressed air, and a liquid, preferably water, as the spray agent being supplied through feed hoses at a pressure of at least 2 bar, the supplied water quantity being less than 1%, preferably less than 0.30%, of the supplied air quantity.

This nonprovisional application is a continuation of International Application No. PCT/DE2017/100700, which was filed on Aug. 22, 2017, and which claims priority to German Patent Application No. 10 2016 013 001.6, which was filed in Germany on Oct. 31, 2016, and German Patent Application No. 10 2017 101 850.6, which was filed in Germany on Jan. 31, 2017, which are all herein incorporated by reference.

### BACKGROUND OF THE INVENTION

### Field of the Invention

The present invention relates to a method for the automated cleaning of lamellar heat exchangers. The invention also relates to an installation arrangement comprising a lamellar heat exchanger and a cleaning device for the lamellar heat exchanger.

### Description of the Background Art

Various methods are known and available for cleaning lamellar heat exchangers and other sensitive surfaces. To automatically clean these lamellar heat exchangers, water spray nozzles are usually used, which are installed side by side and are automatically guided over the surfaces to be cleaned at a pressure of, for example, 50 bar or more. To operate the nozzles, relatively large amount of water are needed, which must be provided and disposed of or treated. Due to the relatively low speed of the water when emerging from the nozzle and the high density of the water, a braking effect also occurs in the narrow channels of the lamellar heat exchanger. This results in the fact that water may indeed demonstrate a good cleaning effect on the front side. However, the cleaning effect may continuously decrease as the water enters deeper and deeper into the heat exchanger, i.e. at a greater structural depth. The result is that the front side may be clean. However, the cleaned lamellar heat exchange has poor throughput values. This results in much higher cleaning costs or in the fact that the power of a unit interacting with the lamellar heat exchanger must be restricted, for example a turbine power, due to the deficient heat dissipation. In addition, damage to the sensitive plates does not occur when the water jet strikes the lamellar heat exchangers.

Methods are known from DE 10 2012 014 605 A1, which corresponds to US 2015/0129171, which is incorporated herein by reference, and from EP 2 877 806 A1, in which air is used as the carrier gas to clean heat exchangers, and liquid is added in small amounts to the carrier gas as the spray agent. The spray nozzles used here preferably have a convergent-divergent design in the form of Laval nozzles. The high spraying speed, which may reach supersonic speeds, ensures that the spray medium penetrates the entire structural depth of the heat exchanger. Moreover, an additional cavitation effect may occur at adapted speeds. This results in a complete or almost complete removal of existing dirt residues.

### SUMMARY OF THE INVENTION

It is therefore an object of the present invention to provide an improved method for the automated cleaning of lamellar heat exchangers as well as an installation arrangement comprising a lamellar heat exchanger and a cleaning device.

The invention provides a method for the automated cleaning of lamellar heat exchangers or other sensitive surfaces, a moving apparatus, preferably moved on rollers or skids, being moved up and down on a guide unit made up of one and preferably two guide rails, on which a support arm is mounted, on which at least one and preferably multiple spray nozzles are mounted in such a way that they are preferably moved along with the guide unit by the moving apparatus with the aid of an additional drive unit via a roller mounted on another end or a toothed wheel, a carrier gas, preferably compressed air, and a liquid, preferably water, as the spray agent being supplied through feed hoses at a pressure of at least 2 bar, the supplied water quantity being less than 1%, preferably less than 0.30%, of the supplied air quantity.

An advantage of the invention is that the automated cleaning of the lamellar heat exchangers or other sensitive surfaces may be carried out quickly, completely, cost-effectively and with a high quality. A spray medium comprising the carrier gas and the spray agent ensures a good cleaning effect. At the same time, the cleaning takes place in a very resource-conserving manner, due to the small water quantity.

The cleaning preferably takes place at a maximum pressure of 16 bar for the carrier gas. A volume flow rate essentially depends on the pressure and a minimum cross section of the spray nozzle. It is, for example, 6 m³/min at a pressure of 6 bar. The travel speed is preferably in the range from 10 to 450 mm/sec. The pressure of the liquid supplied as the spray agent is higher than the pressure of the carrier gas. The spray nozzle is designed, for example, as a convergent-divergent spray nozzle, in this case preferably as a Laval nozzle. For example, the nozzle may provide an annular opening gap for the spray medium as well as a mixing chamber for the carrier gas and the spray agent and a spray agent distribution chamber surrounding the mixing chamber in a ring-shaped manner, at least in sections. The provision of the mixing chamber and the at least ring-segment-shaped spray agent distribution chamber favor a good mixing of the carrier gas with the spray agent. The good mixing ensures an improved homogeneity of the spray medium and improves the cleaning effect.

According to an embodiment of the invention, the guide unit is fixed together with the guide rails on a ladder or bridge unit which may roll or slide over the length of the heat exchanger. In particular large lamellar heat exchangers and those disposed at an incline with respect to the horizontal are often advantageously equipped with ladder or bridge units, for example for inspecting the heat exchanger. They may be pushed in a longitudinal direction of the heat exchanger. The method may be very easily carried out and cost-effectively implemented if the existing structural components are reused, and the movability or slidability of the ladder or bridge unit is used to move the moving apparatus together with the spray nozzles fixed thereon.

The spray nozzles can be fastened to a height- and side-adjustable holder on the support arm. The height adjustment or the lateral adjustment may advantageously make it possible to adapt the cleaning method to different local conditions. For example, it may be necessary to adapt the cleaning device solely in the area of the holder.

A controller for carrying out the method can be automatically operated in such a way that the guide unit is moved together with the ladder or bridge unit and, coordinately therewith, the moving apparatus is moved up and down in the guide rails of the guide unit via the drive unit in such a way that the spray nozzles completely clean the entire surface of the lamellar heat exchanger. A movement, in particular of the moving apparatus, in the guide rails may preferably take place continuously at a constant or variable speed. The ladder or bridge unit may be moved step by step or continuously. For this purpose, a pulling apparatus is preferably actuated by the controller, which moves the ladder or bridge unit in the longitudinal direction of the lamellar heat exchanger, for example via a pulling cable. For example, the ladder or bridge unit may have a self-propelled design and be provided with a drive which interacts with the controller.

The controller may simultaneously vary the pressure and the quantity of the spray medium (carrier gas and spray agent) and, in particular also coordinate the travel speed of the moving apparatus in the longitudinal direction of the lamellar heat exchanger as well as perpendicularly thereto. Safety or monitoring devices, in particular sensors, may be provided to monitor the pressure and the quantity of the spray medium or at least individual components of the spray medium. Likewise, the mechanical (tensile) forces may be monitored via sensors when moving the ladder or bridge unit and the moving apparatus.

A plurality of spray nozzles can be used to clean the lamellar heat exchanger, and different spray media are used for the different spray nozzles. For example, a preferably water-soluble cleaning agent is added in addition to the water in a front spray nozzle with respect to a travel direction of the ladder or bridge unit. For example, small quantities of liquids, such as surfactants and/or enzymes and/or bacteria and/or neutral, alkaline or acidic liquid additives are used as the spray agent. The rear spray nozzle with respect to the travel direction then uses water, for example, as the spray agent and removes residues of the previously used spray agent.

If a variety of different spray agents is employed, different spray nozzles adapted to the different spray agents may be used. The travel speed or the feed rate may be selected in such a way that a repeated treatment of the surfaces of the heat exchanger is ensured.

The lamellar heat exchanger can be cleaned in two stages. In a first cleaning stage, a first partial surface of the lamellar heat exchanger is cleaned by two or more spray nozzles, spaced a distance apart, at a first, low speed. In a second cleaning stage, the speed is then increased, and another, second partial surface of the lamellar heat exchanger is cleaned. Individual cleaning nozzles may be at least optionally deactivated in the first and second cleaning stages. The two-stage cleaning is preferably used if the spray nozzles must be installed to the side of the ladder or bridge unit, due to their large structural length, and a full-surface cleaning of the lamellar heat exchanger is possible only if at least one spray nozzle is installed on each of the two opposite longitudinal sides of the ladder or bridge unit, due to the limited movability of the ladder or bridge unit. In the case of the two-stage cleaning method, it may thus be provided that all spray nozzles are actuated during the first cleaning stage for cleaning the lamellar heat exchanger. The first cleaning stage lasts until the rear spray nozzles with respect to the travel direction of the ladder or bridge unit in the longitudinal direction of the heat exchanger are guided into the area of the lamellar heat exchanger which has already been cleaned by the front nozzles in the travel direction. The second stage of the cleaning process is then activated, at least individual spray nozzles, namely preferably the rear spray nozzles in the travel direction, are deactivated, and the cleaning takes place solely with the aid of the front spray nozzles. It is particularly advantageous if the number of front spray nozzles is greater than the number of rear spray nozzles. The cleaning may then be carried out at a higher speed in the second cleaning stage than in the first cleaning stage. This reduces the overall time required for cleaning.

In terms of the apparatus, the invention provides an installation arrangement comprising at least one lamellar heat exchanger device, which is arranged in a horizontally or vertically oriented manner or inclined at an acute positioning angle with respect to the horizontal, including two feed-through surfaces and a large number of feed-through channels, which are led from a first feed-through surface of the lamellar heat exchanger to a second feed-through surface. A cleaning device is furthermore provided, comprising a guide unit having at least one guide rail, which is arranged to extend in parallel or approximately in parallel to the first feed-through surface and/or to the second feed-through surface, comprising a moving apparatus having a support arm guided on the guide rail, including at least one spray nozzle mounted on the support arm, which is oriented in such a way that a spray agent emerging from the spray nozzle strikes the feed-through surface of the lamellar heat exchanger facing the spray nozzle at an angle of ±20° with respect to the surface normal, and including a drive unit for moving the moving apparatus along the guide rail, and comprising a feed apparatus having at least one feed hose for the spray medium supplied to the spray nozzle, which provides a carrier gas and a small quantity of the liquid supplied by the carrier gas as a spray agent. The installation arrangement furthermore includes a controller for controlling the movement of the moving apparatus and/or a quantity throughput for the spray medium.

The guide unit, together with the moving apparatus fixed in the guide unit, is movably provided in a longitudinal direction of the lamellar heat exchanger, and the controller controls the movement of the moving apparatus in such a way that the spray medium acts upon and cleans all feed-through channels of the lamellar heat exchanger. The longitudinal direction preferably extends horizontally.

An advantage of the invention is that the automated cleaning of a lamellar heat exchanger of a heat exchanger device may take place particularly easily, quickly and economically. For this purpose, a moving apparatus, including the spray nozzles fixed thereon, is guided in a coordinated manner over the lamellar heat exchanger both horizontally and perpendicularly thereto in such a way that the feed-through channels of the lamellar heat exchanger are cleaned by the spray medium (carrier gas+spray agent).

The cleaning device of the installation arrangement according to the invention may be designed to be replaceable in such a way that, on a heat exchanger device having a ladder or bridge unit, it is temporarily mounted thereon for the purpose of cleaning the heat exchanger device. The investment costs and the payback period are reduced hereby.

The horizontal movement of the moving apparatus takes place in the longitudinal direction of the lamellar heat exchanger with the aid of a ladder or bridge unit, which is often provided in any case as part of the heat exchanger device. The guide unit is fixed on the ladder or bridge unit for this purpose. The guide rails of the guide unit are preferably extended transversely to the longitudinal direction of the lamellar heat exchanger. The moving apparatus may thus be guided in two orthogonal directions and independently of each other over the surfaces of the lamellar heat exchanger.

Since the spray nozzles used to carrying out the method according to the invention are typically designed as flat nozzles for the necessary area performance, these spray nozzles are typically very long, due to the necessary flow conduction. This makes the automated use as well as the use of the relatively stiff feed hoses required for generating and supplying compressed air more difficult. The spray nozzles are therefore preferably moved along with the guide unit. The guide rails of the guide unit may be made up of U rails, for example, along which the moving apparatus is guided, for example on rollers. The moving apparatus may be moved, for example, with the aid of a winch having a cable pull, with the aid of a driven toothed belt, a toothed rod or a pull chain. The entire guide unit may also be guided over the surface to be cleaned via another pulling apparatus. For this purpose, the guide unit may be fixed on the ladder or bridge unit or another traversing unit, which is then pulled across the entire length of the heat exchanger, including the guide unit.

For example, the heat exchanger device is designed in the manner of a V-type heat exchanger device or an inverted V-type heat exchanger, comprising two lamellar heat exchangers positioned at an acute angle with respect to each other. For example, the heat exchanger device may provide a recumbent, i.e. horizontally extending, lamellar heat exchanger or a vertically extending heat exchanger. In horizontally extending heat exchangers, in particular, struts or profiles may be provided, which extend between individual cells of the heat exchanger and support the longitudinally slidable ladder or bridge unit.

A plurality of spray nozzles can be provided on the moving apparatus, at least one spray nozzle being preferably installed on each of the longitudinal sides of the ladder or bridge unit situated opposite each other. Due to a corresponding installation of the spray nozzles, a complete cleaning of the lamellar heat exchanger may preferably be achieved even if the ladder or bridge unit is unable to be moved therebeyond in the longitudinal direction of the lamellar heat exchanger, and thus the spray nozzles installed next to the ladder or bridge unit in the area of the longitudinal sides thereof are each able to clean only a partial surface of the lamellar heat exchanger. The arrangement of at least two spray nozzles spaced a distance apart thus ensures that the lamellar heat exchanger is able to be completely cleaned despite the geometric restrictions or the limited movability of the ladder or bridge unit.

Additional advantages, features and details of the invention are apparent from the additional subclaims and the following description. Features mentioned therein may each be essential to the invention both individually or in any arbitrary combination. Features and details of the installation arrangement described according to the invention naturally also apply in connection with the method according to the invention and vice versa. Thus, reference may always be made interchangeably to the disclosure of the individual aspects of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective schematic view of an installation arrangement;

FIG. 2 shows a longitudinal side view of the installation arrangement according to FIG. 1;

FIG. 3 shows an end face view of the installation arrangement according to FIG. 1;

FIG. 4 shows an enlarged representation of a detail X according to FIG. 3;

FIG. 5 shows a front view of a cleaning device of the installation arrangement according to FIG. 1;

FIG. 6 shows an rear view of the installation arrangement according to FIG. 5;

FIG. 7 shows an longitudinal side view of the cleaning device according to FIG. 5;

FIG. 8 shows a top view of the cleaning device according to FIG. 5; and

FIG. 9 shows an embodiment of the installation arrangement according to the invention.

### DETAILED DESCRIPTION

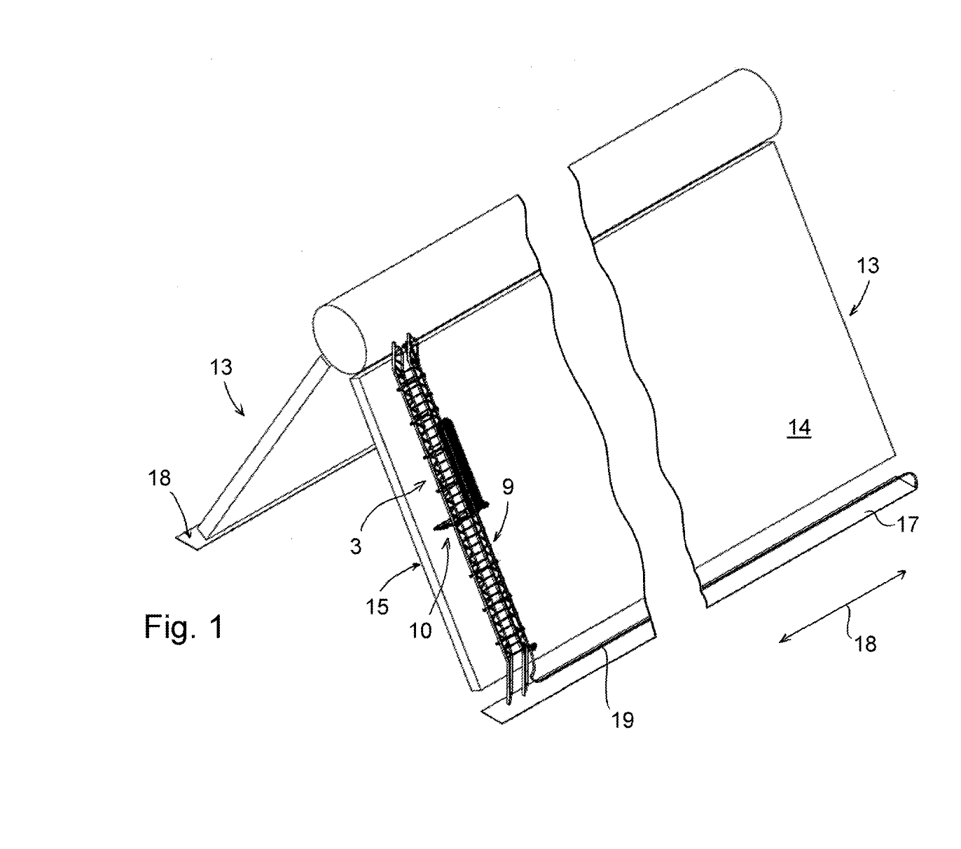

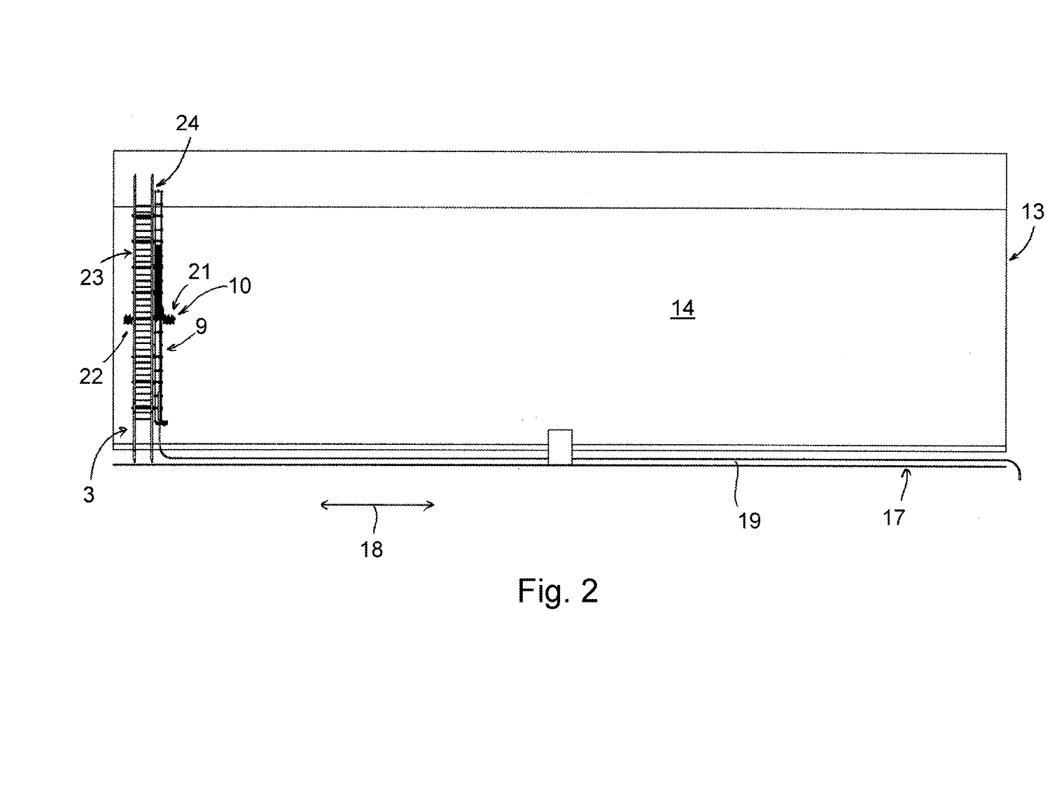

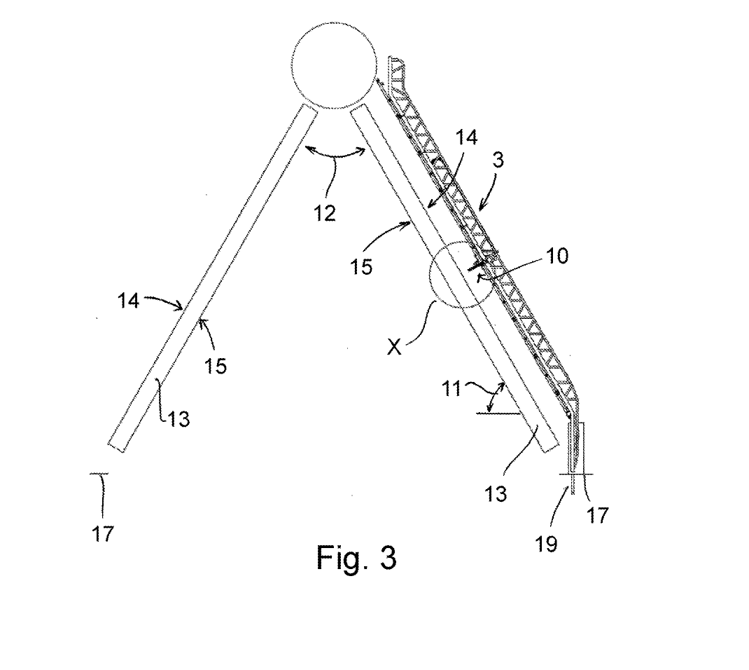

An installation arrangement according to the invention according to FIGS. 1 through 3 comprises an inverted V-type heat exchanger device, which includes two lamellar heat exchangers 13 installed at an acute positioning angle 11 with respect to the horizontal and an acute positioning angle 12 with respect to each other. Lamellar heat exchangers 13 have two feed-through surfaces 14, 15, situated opposite each other, as well as a large number of feed-through channels 16, which are led from a first feed-through surface 14 to a second feed-through surface 15. Lamellar heat exchangers 13 are used, for example, to cool an air flow conducted through them.

An accessibility of the lamellar heat exchangers 13 is provided, on the one hand, by horizontally extending webs 17 and, on the other hand, by a ladder or bridge unit 3. Ladder or bridge unit 3 covers lamellar heat exchangers 13 in the area of first feed-through surface 14. It is movably disposed in a longitudinal direction 18 of lamellar heat exchangers 13 and is preferably guided via a guide in the area of webs 17.

A guide unit 9, which includes two guide rails 1 disposed in parallel and at a distance from each other, is fixed on ladder or bridge unit 3. Guide unit 9 carries a moving apparatus 10, which is supported on guide unit 9, for example via rollers 4, and is movable in a longitudinally slidable manner along guide rails 1 of guide unit 9. Moving apparatus 10 is moved along guide rails 1 via a drive unit 2, a traction mechanism (cable pull, chain pull, toothed belt, toothed rod or the like) and a deflecter (roller or toothed wheel 8). Spray nozzles 6 are fixed on moving apparatus 10. A support arm 5 and a holder 7 for the height and lateral adjustment of spray nozzles 6, which extends, for example horizontally, is used to fix spray nozzles 6.

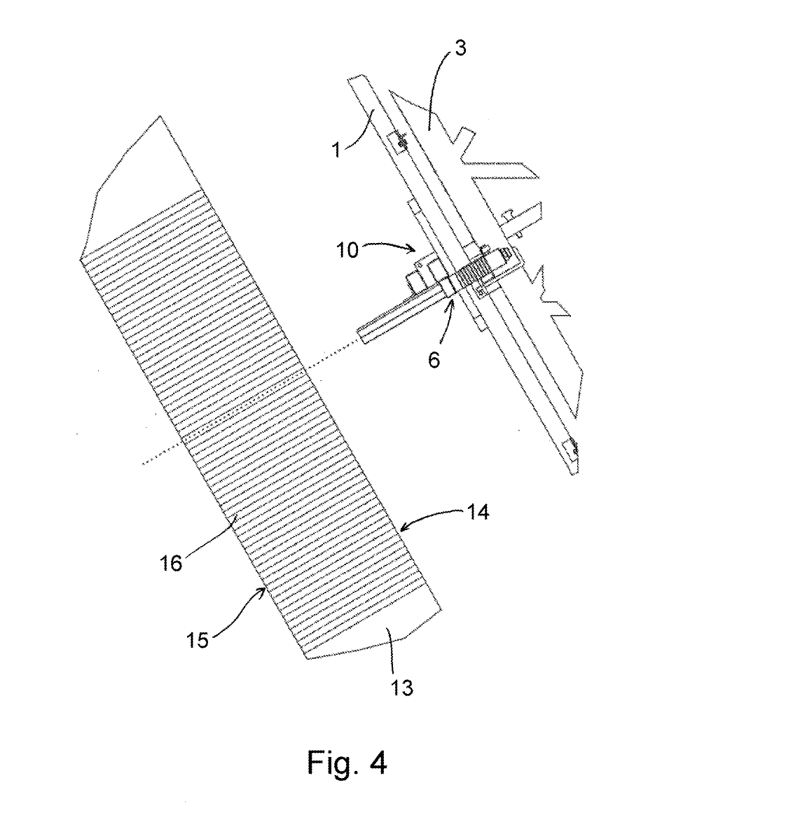

A spray medium is provided with the aid of spray nozzles 6 for cleaning lamellar heat exchangers 13. The orientation of spray nozzles 6 is provided in such a way that the spray medium perpendicularly strikes first feed-through surface 14 of lamellar heat exchangers 13 and passes through feed-through channel 16; cf. FIG. 4. Since spray nozzles 6 in the present exemplary embodiment of the invention are comparatively long and are therefore unable to be positioned between ladder or bridge unit 3, on the one hand, and feed-through surface 14, on the other hand, they are preferably installed adjacent to ladder or bridge unit 3. A carrier gas, preferably compressed air, which is provided at at least 2 bar, is used as the spray medium, as well as a liquid as the spray agent, which is supplied to the carrier gas. Water, for example, is used as the liquid. The quantity of liquid supplied is less than 1% and preferably less than 0.3% of the supplied carrier gas quantity.

The spray medium is supplied via a feed apparatus, which includes at least one feed hose 19 and preferably a plurality of feed hoses 19. For example, the carrier gas and the spray agent may be supplied via separate feed hoses 19 or be mixed prior to feeding and be conducted to spray nozzle 6 via a shared feed hose 19. Separate feed hoses 19 are provided for each spray nozzle 6. Feed hoses 19 are guided via a cable carrier 20 in the area of guide rails 1.

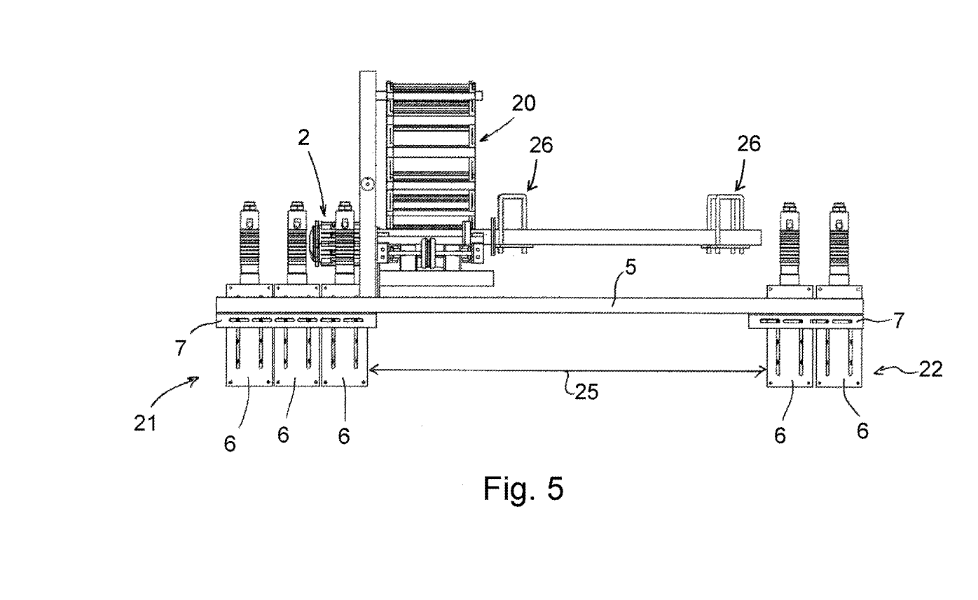

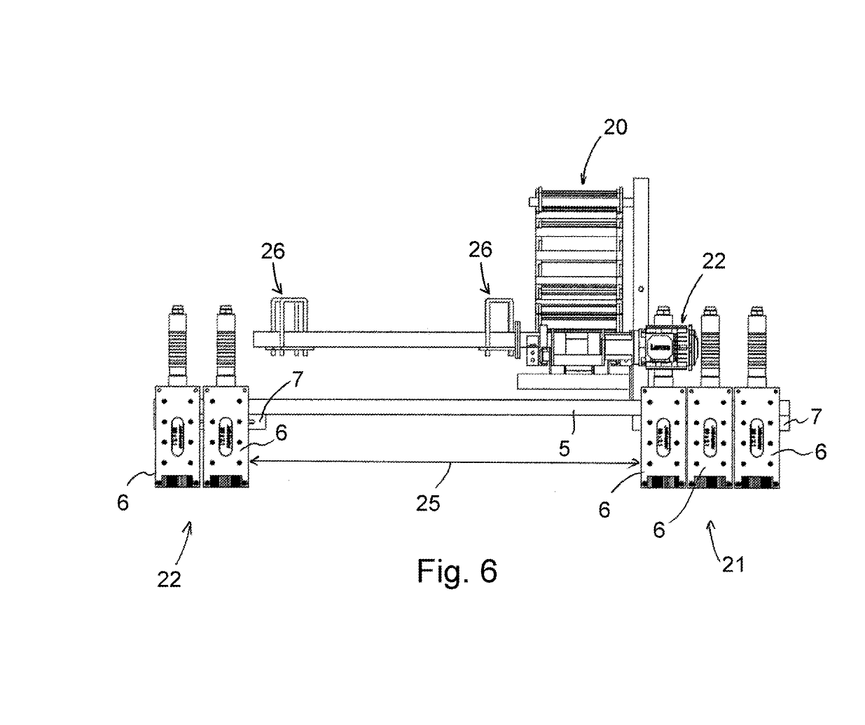

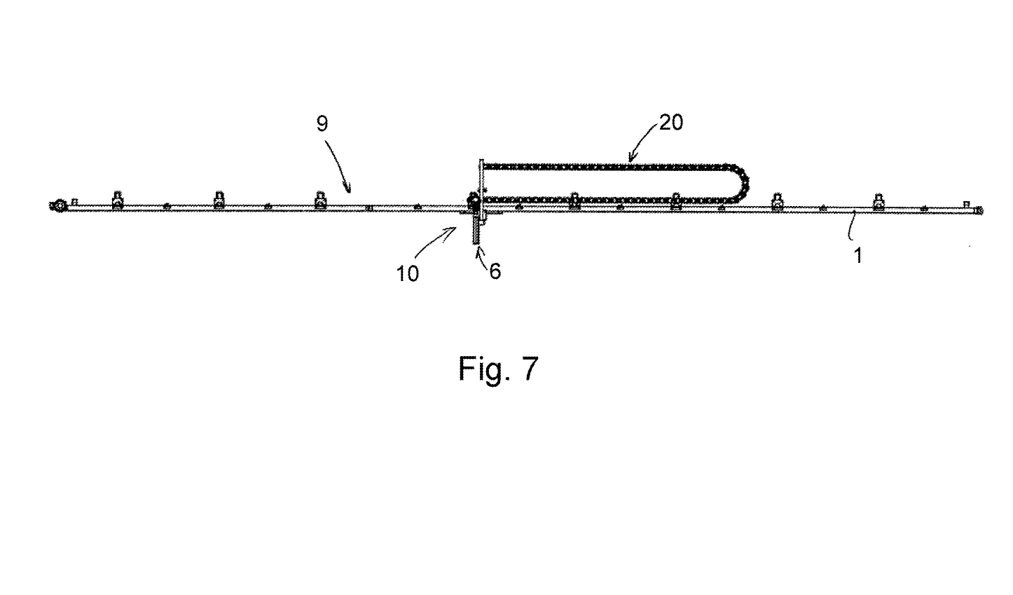

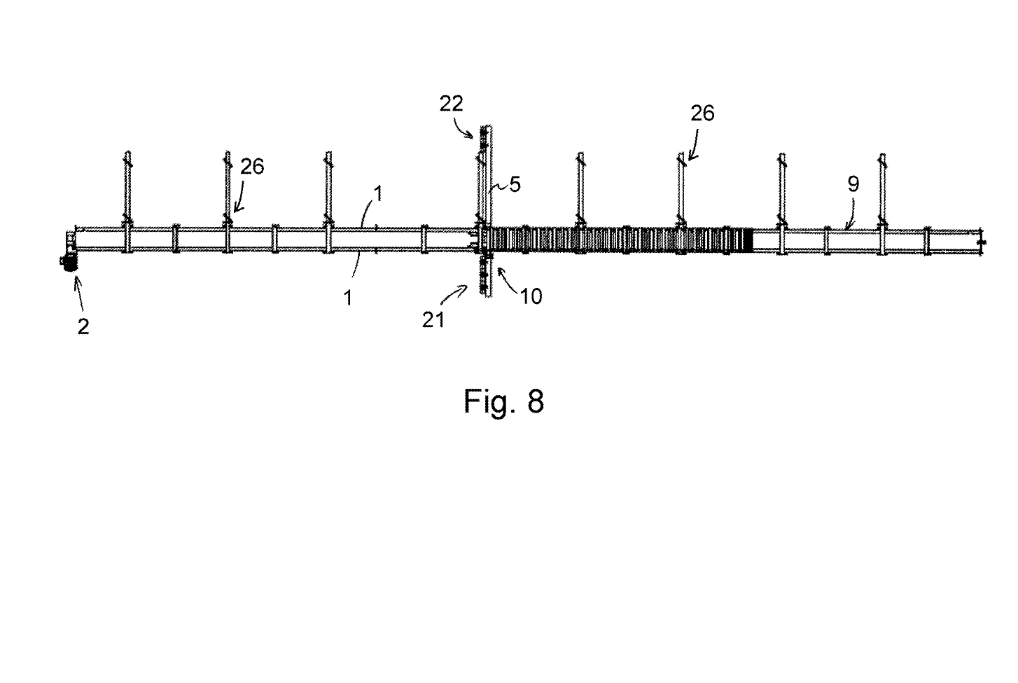

Guide unit 9, including guide rails 1, moving apparatus 10 as well as the feed apparatus having the at least one feed hose 19 belong to a cleaning device of the installation arrangement according to the invention. The cleaning device is illustrated with respect to essential details in FIGS. 5 through 8. In the present case, the cleaning device provides a total of five spray nozzles 6, which are installed in two groups 21, 22 on opposite longitudinal sides 23, 24 of ladder or bridge unit 3. A clear distance 25 between groups 21, 22 is selected in such a way that ladder or bridge unit 3 is disposed between groups 21, 22. For this purpose, the cleaning device provides fastener 26, which are used to fix guide rails 1.

The three spray nozzles 6 belonging to first group 21 are disposed upstream from the two spray nozzles 6 belonging to second group 22 with regard to a traversing direction of ladder or bridge unit 3 in longitudinal direction 18 of lamellar heat exchangers 13.

A cleaning of lamellar heat exchanger 13 with the aid of the cleaning device takes place according to the invention in such a way that moving apparatus 10, including spray nozzles 6, is moved via guide unit 9 with ladder or bridge unit 3 in longitudinal direction 18 of lamellar heat exchanger 13, and moving apparatus 10 is additionally moved up and down perpendicularly to longitudinal direction 18 along first feed-through surface 14. The cleaning method preferably takes place in two stages in such a way that, in a first cleaning stage, a first partial surface of lamellar heat exchanger 13 is cleaned at a low first speed. The first cleaning stage continues to run until spray nozzles 6 of second group 22 of spray nozzles 6 is moved in the longitudinal direction by clear distance 25 of groups 21, 22 of spray nozzles 6. The first cleaning stage is thus used to clean a partial area of lamellar heat exchanger 13 originally assigned to ladder or bridge unit 3. Once the first partial surface of lamellar heat exchanger 13 has been cleaned, spray nozzles 6 of second group 22 may be deactivated, and the remaining second partial surface of lamellar heat exchanger 13 may be cleaned by spray nozzles 6 of first group 21 of spray nozzles 6. The speed of the cleaning may be selected to be higher, due to the larger number of parallel spray nozzles 6. For example, the moving apparatus 10 may be moved continuously along guide rails 1 of guide unit 9. For example, the movement in longitudinal direction 18 of lamellar heat exchangers 13 may take place step by step.

Spray nozzles 6 are moved along first feed-through surface 14 of lamellar heat exchanger 13 via a controller, which is not illustrated. The controller may be simultaneously provided to control and, in particular, to activate and deactivate spray nozzles 6 and to control or regulate a pressure of the spray medium or a quantity of the spray medium.

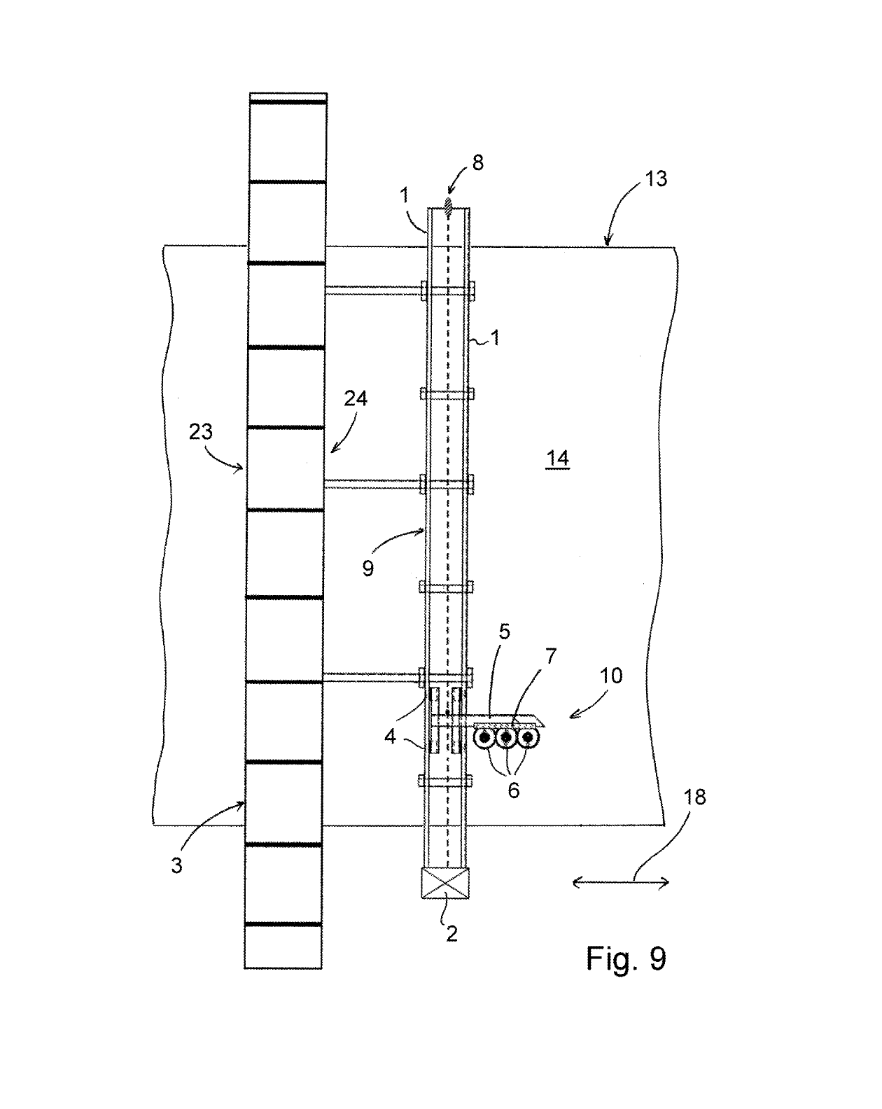

According to an alternative specific embodiment of the invention according to FIG. 9, in a setup of the installation arrangement which is otherwise essentially the same, only a first group 21 including three spray nozzles 6 is provided, which is installed on one side of ladder or bridge unit 3. The second specific embodiment of the installation arrangement is suitable, in particular when ladder or bridge unit 3 may be moved and traversed in very wide areas even outside lamellar heat exchanger 13. In this case, a cleaning of assigned lamellar heat exchanger 13 may take place in one stage.

According to another specific embodiment of the invention, which is not illustrated, spray nozzles 6 as a whole or at least one group 21, 22 of spray nozzles 6 may be provided on a side of ladder or bridge unit 3 facing away from heat exchanger 13. A cleaning of heat exchanger 13 may then take place particularly easily over the entire traversing distance of ladder or bridge unit 3.

According to another specific embodiment of the invention, which is not illustrated, the moving apparatus 10 may be moved in a first movement direction by a first drive unit 2 via a first traction mechanism and by a second drive unit 2 via a second traction mechanism. In particular, this approach may be used for horizontally installed heat exchangers 13.

Identical components and component functions are marked by the same reference numerals.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A method for the automated cleaning of lamellar heat exchangers and other sensitive surfaces, the method comprising:
moving, a moving apparatus moved on rollers or skids, up and down on a guide unit made up of one or two guide rails, on which a support arm is mounted, on which at least one or multiple spray nozzles are mounted such that they are moved along with the guide unit via the moving apparatus with the aid of an additional drive unit, via a roller or a toothed wheel mounted on another end; and
supplying a carrier gas, preferably compressed air, and a liquid, preferably water, as a spray agent through feed hoses at a pressure of at least 2 bar, the supplied water quantity being less than 1% or less than 0.30% of a supplied air quantity.

2. The method according to claim 1, wherein the guide unit is connectable to a ladder or bridge unit which is adapted to be rolled or pushed over a length of the heat exchanger.

3. The method according to claim 1, wherein the spray nozzles are fastened to the support arm by a height- and side-adjustable holder.

4. The method according to claim 1, wherein the entire guide unit, including the ladder or bridge unit, which is adapted to be rolled and/or pushed and/or self-propelled over the length of the heat exchanger, is automatically guided over the surface to be cleaned by a suitable pulling apparatus, preferably a cable pull, via a controller in such a way that the spray nozzles completely clean the entire surface.

5. The method according to claim 1, wherein the pressure and quantity of carrier gas and spray agent and the travel speed of the moving apparatus and the guide unit is adapted to be regulated.

6. The method according to claim 1, wherein at least one spray nozzle is installed on each of opposite longitudinal sides of the ladder or bridge unit and the lamellar heat exchanger is cleaned in two stages, a first partial surface of the lamellar heat exchanger being cleaned in a first cleaning stage, in that the guide unit is moved in a longitudinal direction of the lamellar heat exchanger at a first speed until the guide unit has moved in the longitudinal direction by a clear distance of the spray nozzles installed on opposite longitudinal sides of the ladder or bridge unit, and in a second cleaning stage, another, second partial surface of the lamellar heat exchanger is cleaned in that the guide unit is moved in the longitudinal direction of the lamellar heat exchanger in a second stage at a second speed, the second speed being higher than the first speed.

7. The method according to claim 6, wherein at least individual spray nozzles are deactivated in the first cleaning stage and/or in the second cleaning stage.

8. An installation arrangement comprising:
at least one heat exchanger, which includes a lamellar heat exchanger, arranged in a horizontally oriented or vertically oriented manner or inclined at an acute positioning angle with respect to the horizontal;
two feed-through surfaces arranged opposite each other; and
a plurality of feed-through channels, which are led from a first feed-through surface to a second feed-through surface, including a cleaning device;
a guide unit that has at least one guide rail that is disposed to extend in parallel to the first feed-through surface and/or to the second feed-through surface;
a moving apparatus guided on the guide rail, which includes a support arm with at least one spray nozzle mounted on the support arm, which is oriented such that a spray agent emerging from the spray nozzle strikes the feed-through surface of the lamellar heat exchanger facing the spray nozzle at an angle of ±20° with respect to a surface normal;
a drive unit for moving the moving apparatus along the guide rail; and
a feed apparatus, which includes at least one feed hose for the spray medium supplied to the spray nozzle, which provides a carrier gas and a small quantity of liquid supplied by the carrier gas as the spray agent; and
a controller for controlling the movement of the moving apparatus and/or a quantity throughput for the spray medium, the guide unit, together with the moving apparatus fixed on the guide unit being movably provided in a longitudinal direction of the lamellar heat exchanger, and the controller controlling the movement of the moving apparatus such that the spray medium passes through all feed-through channels of the lamellar heat exchanger.

9. The installation arrangement according to claim 8, wherein the heat exchanger is a V-type heat exchanger device or an inverted V-type heat exchanger, comprising two lamellar heat exchangers installed at an acute positioning angle with respect to each other.

10. The installation arrangement according to claim 8, wherein the guide unit is fixed on a ladder or bridge unit, which is adapted to be pushed in a longitudinal direction of the lamellar heat exchanger, the guide rail of the guide unit extending transversely to the longitudinal direction of the lamellar heat exchanger.

11. The installation arrangement according to claim 8, wherein a plurality of spray nozzles are provided on the moving apparatus, and wherein at least one spray nozzle is installed on opposite longitudinal sides of the ladder or bridge unit.

12. The installation arrangement according to claim 8, wherein the controller is designed to carry out the method according to claim 1.
